(19) United States
(12) Patent Application Publication
(10) Pub. No.: US 2024/0309157 A1
(43) Pub. Date: Sep. 19, 2024

(54) RUBBER-GRAPHENE COMPOSITE AND METHOD FOR PRODUCING THE SAME

(71) Applicant: Ford Global Technologies, LLC, Dearborn, MI (US)

(72) Inventors: Rodrigo Denizarte de Oliveira Polkowski, Salvador (BR); Ricardo Albuquerque, Salvador (BR); Veronica Alves Veloso, Caxias do Sul (BR); Willian Belincanta Ribeiro, Caxias do Sul (BR); Marcelo Santiago, Lauro de Freitas (BR); Eduardo Pinto, Camaçari (BR)

(73) Assignee: Ford Global Technologies, LLC, Dearborn, MI (US)

(21) Appl. No.: 18/183,572

(22) Filed: Mar. 14, 2023

(51) Int. Cl. C08J 5/00; B29C 35/02; B29C 48/00; C08K 3/04; C08K 3/36

(52) U.S. Cl. CPC C08J 5/005; B29C 35/02; B29C 48/022; C08K 3/04; C08K 3/36; B29K 2009/00; B29K 2307/04; C08J 2309/00; C08K 3/042; C08K 2201/014

(57) ABSTRACT

A rubber-graphene composite includes a paste and a rubber matrix, wherein the paste is mixed with the rubber matrix. The paste includes graphene, a plasticizer, and at least one additive selected from the group consisting of carbon black, biochar, and rice husk ash silica. A method for preparing a rubber-graphene composite includes mixing graphene with a plasticizer and at least one additive selected from the group consisting of carbon black, biochar, and rice husk ash silica to form a paste; mixing the paste with a rubber matrix to form an intermediate composite; accelerating the intermediate composite to form a final composite; and extruding and curing the final composite.

### FIELD

The present disclosure relates to reinforced rubber composites and methods for preparing the same.

### BACKGROUND

The statements in this section merely provide background information related to the present disclosure and may not constitute prior art.

Incorporating graphene and/or graphene-based species (e.g., graphene oxide, reduced graphene oxide, graphene nanoplatelets, among others) into rubber can provide improved mechanical, thermal, and electrical properties to create multifunctional rubber materials. Specifically, using graphene and/or graphene-based species as fillers in rubber composites can provide high impermeability, thermal and wear resistance, and antistatic properties, among others.

Conventional graphene and rubber composite forming methods have employed solution mixing, latex compounding, and mixing in an internal mixer, or combinations thereof. However, these methods are expensive, inefficient, and are limited to laboratory scale. Methods employing solution mixing use a large amount of organic solvent, which can be difficult and expensive to dispose of or recycle. Additionally, when using latex compounding, nanofillers may agglomerate in the rubber matrix and the process involves high water consumption.

The present disclosure addresses these concerns and provides a rubber-graphene composite and a more efficient, less expensive, environmentally friendly, and scalable method of producing rubber composites.

### SUMMARY

This section provides a general summary of the disclosure and is not a comprehensive disclosure of its full scope or all of its features.

In one form of the present disclosure, a rubber-graphene composite includes a paste and a rubber matrix, wherein the paste is mixed with the rubber matrix. The paste includes graphene; a plasticizer; and at least one additive selected from the group consisting of carbon black, biochar, and rice husk ash silica.

In variations of this form, which may be implemented individually or in any combination: the graphene includes at least one of graphene nanoplatelets, graphene oxide, and reduced graphene oxide; the plasticizer includes at least one of paraffinic oil, naphthenic oil, vegetable oil, modified vegetable oil, dioctyl terephthalate (DOTP), trioctyl trimellitate (TOTM), and phenolic resin; the rubber matrix is selected from the group consisting of butyl rubber, nitrile rubber, and ethylene-propylene-diene rubber; the composite further includes at least one additional additive selected from the group consisting of an antiozonant, an antioxidant, an activator, a cure accelerator, and a cure agent; the activator comprises at least one of zinc oxide and stearic acid; the cure accelerator comprises at least one of benzothiazole disulfide (MBTS), tetramethylthiuram disulfide (TMTD) and zinc dibenzyl dithiocarbamate (ZDBC); and the rubber-graphene composite has a shore A hardness between 60 and 80 measured according to ASTM D2240, a tensile strength at break greater than 10 MPa measured according to ASTM D412, an elongation at break greater than 240% measured according to ASTM D412, and an electrical resistivity of about 100 MΩ measured according to SAE J2260. In further aspects of this form of the present disclosure, a part includes the rubber-graphene as described previously.

In another form of the present disclosure, a rubber-graphene composite includes a paste and 100 parts per hundred rubber (phr) of a rubber matrix, wherein the paste is mixed with the rubber matrix. The paste includes 1-70 parts per hundred rubber (phr) total of graphene and a plasticizer; 0-200 parts per hundred rubber (phr) of N550 carbon black; 0-60 parts per hundred rubber (phr) of a conductive carbon black; 0-80 parts per hundred rubber (phr) rice husk ash silica; and 0-10 parts per hundred rubber (phr) of each of at least one additional additive selected from the group consisting of an antiozonant, an antioxidant, an activator, a cure accelerator, and a cure agent.

In variations of this form, which may be implemented individually or in any combination: the rubber-graphene composite has a shore A hardness between 60 and 80 measured according to ASTM D2240, the rubber-graphene composite has a tensile strength at break greater than 10 MPa measured according to ASTM D412, the rubber-graphene composite has an elongation at break greater than 240% measured according to ASTM D412, and the rubber-graphene composite has an electrical resistivity of about 100 MΩ measured according to SAE J2260.

In yet another form of the present disclosure, a method for preparing a rubber-graphene composite includes mixing graphene with a plasticizer and at least one additive selected from the group consisting of carbon black, biochar, and rice husk ash silica to form a paste; mixing the paste with a rubber matrix to form an intermediate composite; accelerating the intermediate composite to form a final composite; extruding the final composite; and curing the final composite.

In variations of this method, which may be implemented individually or in any combination: the graphene includes at least one of graphene nanoplatelets, graphene oxide, and reduced graphene oxide; the plasticizer includes at least one of paraffinic oil, naphthenic oil, vegetable oil, modified vegetable oil, dioctyl terephthalate (DOTP), trioctyl trimellitate (TOTM), and phenolic resin; the rubber matrix is selected from the group consisting of butyl rubber, nitrile rubber, and ethylene-propylene-diene rubber; and the step of mixing graphene with the plasticizer and the at least one additive to form the paste comprises mixing in a high-energy ball mill, wherein the ball milling time is 0.5-12 hours and the ball milling rotating speed is 300-600 rpm. In further aspects of this method of the present disclosure, a part comprises the rubber-graphene composite manufactured according to the method as described previously.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flowchart illustrating a method for producing rubber-graphene composites according to the present disclosure;

FIG. 2 illustrates an example of a part comprising the rubber-graphene composite produced by a method of the present disclosure; and

FIGS. 3A and 3B illustrate a multi-layer part comprising the rubber-graphene composite according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As used herein, “graphene” or “graphenes” include graphene oxide, reduced graphene oxide, nanoplatelets, nanosheets, functionalized graphene, graphene derivatives, and mixtures thereof, among others. The graphene or graphenes may be electrically conductive or electrically nonconductive depending on the type of graphene or graphenes used. For example, graphene oxide and reduced graphene oxide are electrically nonconductive.

Plasticizers improve the processability of rubber composites by reducing the cohesive forces between the polymer chains, allowing for increased chain mobility. Plasticizers also reduce the glass transition temperature of rubber, which is important for low temperature operation conditions. In addition, use of plasticizers in rubber composites provides lower hardness, increased elongation, improved flex life, flame resistance, and improved antistatic performance. As used herein, “plasticizer” or “plasticizers” include chemicals. Particularly, “plasticizer” or “plasticizers” may include at least one of oils (i.e., mineral oils such as aromatic oils, naphthenic oils, and paraffinic oils), esters (such as oleate, sebacate, and phthalate), polymeric plasticizers (such as coumarone and phenolic resins), and vegetable oils (such as castor oil, soybean oil, linseed oil, and palm oil), among others. In an aspect, the graphene-rubber composite of the present disclosure includes plasticizer at greater than or equal to 0 to less than or equal to about 80 parts per hundred rubber (PHR).

As used herein, “rubber matrix” includes nitrile butadiene rubber (NBR), styrene-butadiene rubber (SBR), ethylene propylene diene monomer (EPDM), and mixtures thereof, among others.

In some aspects, additives are added during a step of mixing graphene with a plasticizer (as more fully described below). As used herein, “additive” or “additives” include at least one of carbon black, biochar, silica, and activators.

One optional additive is carbon black, which may include at least one type of carbon black. For example, the additive may include a first carbon black having a low specific surface area and a second carbon black having a high electrical conductivity. The first carbon black provides improved extrudability and mechanical and physical properties. One specific example of the carbon black additive is N550 carbon black. In some variations of the present disclosure, the carbon black additive includes a conductive carbon black. The conductive carbon black may have a high specific surface area and a low surface activity. In an aspect, the graphene-rubber composite of the present disclosure includes carbon black at greater than or equal to 0 to less than or equal to about 200 PHR. In another aspect, the graphene-rubber composite of the present disclosure includes carbon black at greater than or equal to 0 to less than or equal to about 60 PHR. In yet another aspect, the graphene-rubber composite of the present disclosure includes carbon black at greater than or equal to 0 to less than or equal to about 50 PHR.

Another optional additive is biochar, which may include conductive biochar. As used herein, “biochar” should be understood to mean carbon-rich material obtained from the pyrolysis of biomass such as plant or animal waste. In an aspect, the graphene-rubber composite of the present disclosure includes biochar at greater than or equal to 0 to less than or equal to about 80 PHR.

A further optional additive is silica, which may be in the form of rice husk ash silica. More specifically, rice husk ash silica is silica obtained from the combustion of rice husk (i.e., the natural coating of rice grains) and having an amorphous structure. Furthermore, rice husk ash is a silica which may contain a variation of 85% to 95% of pure silica in its composition. The specific surface area of rice husk ash silica ranges from 5 to 35 m²/g and a moisture content of 8.5 to 10.5%. In an aspect, the graphene-rubber composite of the present disclosure includes silica at greater than or equal to 0 to less than or equal to about 80 PHR.

Another optional additive includes activators that improve cross-linking reactions of diene rubbers, improve cross-linking density, improve the speed of vulcanization, and improve the resistance of reversion. Activators may be organic or inorganic, or a combination thereof. Non-limiting examples of activators include stearic acid, palmitic acid, lauric acid, zinc salt of stearic acid, zinc salt of palmitic acid, zinc salt of lauric acid, activators based on thiazoles like mercaptobenzothiazole (MBT), benzothiazole disulfide (MBTS), alkaline activators, and zinc oxide (ZnO), among others. In an aspect, the graphene-rubber composite of the present disclosure includes activator at greater than or equal to 0 to less than or equal to about 10 PHR.

In some aspects, the rubber-graphene composite comprises at least one additional additive (as more fully described below). As used herein, “additional additive” or “additional additives” include at least one of an antiozonant, an antioxidant, a cure accelerator, and a cure agent.

One optional additional additive includes antiozonants. Antiozonants inhibit degradation of rubber compositions by ozone. Non-limiting examples of antiozonants may include N-isopropyl-N′-phenyl-P′-phenylene diamine, N-(1, 3-dimethyl butyl)-N′-phenyl-P-phenylene diamine (6PPD), mixed diaryl-P-phenylene diamine, or bis(1,2,3,6-tetra-hydro-benzaldehyde)-pentaerythrityl acetate. In an aspect, the graphene-rubber composite of the present disclosure includes antiozonant at greater than or equal to 0 to less than or equal to about 5 PHR.

Another of the optional additional additives includes antioxidants. Antioxidants inhibit oxidation of rubber compositions and may be based on phenolics, benzimidazoles, quinolines, phosphites, or amines. Non-limiting examples of antioxidants may include 2,6-di-t-butyl-p-cresol, butylated reaction product of p-cresol & dicyclopentadiene, hindered phenol, 2,2′-methylene-bis-(4-methyl 6-t-butyl phenol), 2,5-di-tert-amyl hydroquinone, 4,4′-butylidenebis (6-tert-butyl-m-cresol), Zn salt of 2-mercapto 4(5)-methylbenzimidazole, 4/5-methyl mercapto benzimidazole, 2,2,4-trimethyl-1,2-hydroquinoline, 2,2,4-trimethyl-1,2-dihydroquinoline, trisnonylphenyl phosphite, phenyl-a-naphthylamine, octylated diphenylamine, or 4,4′-bis(a,a′-dimethylbenzyl/diphenylamine), or a combination thereof. In an aspect, the graphene-rubber composite of the present disclosure includes antioxidant at greater than or equal to 0 to less than or equal to about 5 PHR.

Yet another optional additional additive includes cure accelerators. Cure accelerators increase the speed of vulcanization and allow vulcanization to proceed at a lower temperature and with increased efficiency. Cure accelerators may be based on aldehyde amine, guanidine, thiazole, thiophosphate, sulfonamides, thiourea, thiuram, dithiocarbamate, or xanthates, among others. Non-limiting examples of cure accelerators include heptaldehyde-aniline condensation product (BA), hexamethylenetetramine (HMT), diphenyl guanidine (DPG), diorthotolyl guanidine (DOTG), mercaptobenzothiazole (MBT), benzothiazole disulfide (MBTS), zinc salt of mercaptobenzothiazole (ZMBT), zinc-O,O-di-N-phosphorodithioate (ZBDP), N-cyclohexyl-2-benzothiazole sulfenamide (CBS), N-tert-butyl-benzothiazole sulfonamide (TBBS), 2-(4-morpholinothio)-benzothiazole (MBS), N,N′-dicyclohexyl-2-benzothiazole sulfenamide (DCBS), ethylene thiourea (ETU), di-pentamethylene thiourea (DPTU), dibutyl thiourea (DBTU), tetramethylthiuram monosulfide (TMTM), tetramethylthiuram disulfide (TMTD), dipentamethylenethiuram tetrasulfide (DPTT), tetrabenzylthiuram disulfide (TBzTD), zinc dimethyldithiocarbamate (ZDMC), zinc diethyldithiocarbamate (ZDEC), zinc dibutyldithiocarbamate (ZDBC), zinc dibenzyldithiocarbamate (ZBEC), and zinc-isopropyl xanthate (ZIX). In an aspect, the graphene-rubber composite of the present disclosure includes cure accelerator at greater than or equal to 0 to less than or equal to about 10 PHR.

A further optional additional additive includes curing agents. Curing agents enable crosslinking of rubber compositions and may include sulphur sources, peroxides, metal oxides, amines, phenolic resins, carbon-based sources, and silica-based sources, among others. Non-limiting examples of curing agents may include magnesium oxide (MgO), zinc oxide (ZnO), organic peroxide, and dithiodimorpholine (DTDM). In an aspect, the graphene-rubber composite of the present disclosure may include curing agent at greater than or equal to about 0 to less than or equal to about 10 PHR.

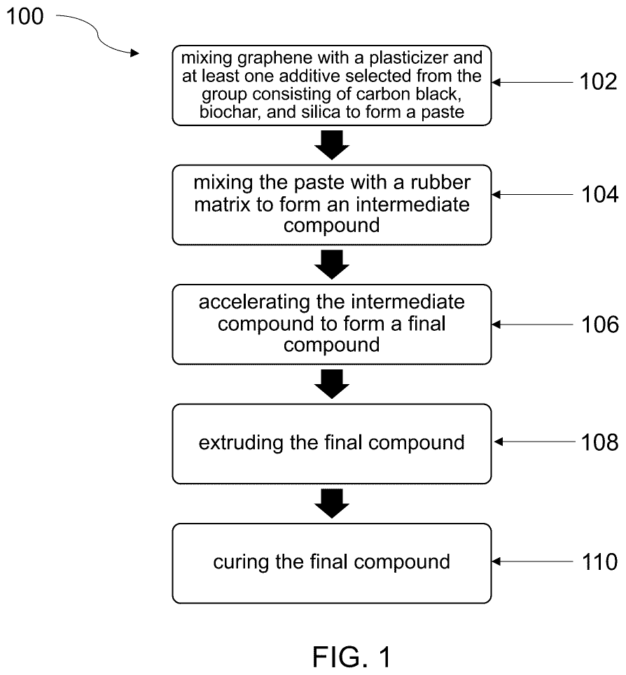

Referring now to FIG. 1, a method 100 for producing a graphene-rubber composite according to one form of the present disclosure includes mixing graphene with a plasticizer and at least one additive selected from the group consisting of carbon black, biochar, and rice husk ash silica to form a paste at 102. In an aspect, the graphene comprises at least one of graphene oxide, reduced graphene oxide, nanoplatelets, and nanosheets, among others. In a further aspect, the plasticizer comprises at least one of paraffinic oil, naphthenic oil, vegetable oil, modified vegetable oil, dioctyl terephthalate (DOTP), trioctyl trimellitate (TOTM), and phenolic resin, among others.

In one form of the present disclosure, the step of mixing graphene with the plasticizer and the at least one additive to form the paste comprises mixing in a high-energy ball mill, wherein the ball milling time is 0.5-12 hours and the ball milling rotating speed is 300-600 rotations per minute (rpm).

At 104, the paste is mixed with a rubber matrix to form an intermediate composite. By way of non-limiting example, the rubber matrix may be selected from the group consisting of butyl rubber, nitrile rubber, and ethylene-propylene-diene rubber. In order to tune the various properties of the rubber-graphene composite, additional additives such as antiozonants, antioxidants, and activators may be added. Specific examples of activators include zinc oxide and stearic acid; however, the present disclosure is not limited thereto.

The intermediate composite is accelerated at 106 to form a final composite. In an aspect of the present disclosure, the acceleration step comprises adding at least one of a cure accelerator and a cure agent to the intermediate composite. In one form, the cure accelerator comprises at least one of benzothiazole disulfide (MBTS), tetramethylthiuram disulfide (TMTD) and zinc dibenzyl dithiocarbamate (ZDBC). However, it should be understood that other cure accelerators can be used without deviating from the scope of the present disclosure. Furthermore, the acceleration step may be carried out using two-roll mill equipment.

The final composite is extruded to acquire a desired shape and then is cured at 108 and 110, respectively. The extrusion step may be carried out using any appropriate type of equipment. Furthermore, by way of non-limiting example, an autoclave may be used to cure the final composite.

In one form of the present disclosure, the rubber-graphene composite comprises a paste which is mixed with 0-100 PHR of a rubber matrix. More specifically, in one variation the rubber-graphene composite comprises a paste which is mixed with 100 PHR of the rubber matrix. The paste comprises 1-70 PHR total of graphene and a plasticizer, 0-200 PHR of N550 carbon black, 0-60 PHR of a conductive carbon black, 0-80 PHR rice husk ash silica, and 0-10 PHR of each of at least one additional additive selected from the group consisting of an antiozonant, an antioxidant, an activator, a cure accelerator, and a cure agent.

In aspects of the present disclosure, the rubber-graphene composite has at least one of a shore A hardness between 60 and 80 measured according to ASTM International (ASTM) D2240, a tensile strength at break greater than 10 MPa measured according to ASTM D412, an elongation at break greater than 240% measured according to ASTM D412, and an electrical resistivity of about 100 MΩ measured according to SAE J2260.

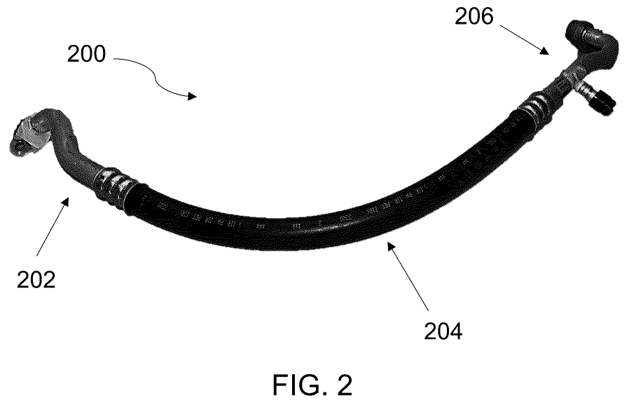

Referring now to FIG. 2, the present disclosure also relates to a part 200 comprising the rubber-graphene composite produced by a method of the present disclosure described above. As shown, the part 200 is an air-conditioning hose for a vehicle. The part 200 includes a first end 202 and a second end 206. A central portion 204 is disposed between and coupled to the first end 202 and the second end 206 and comprises the rubber-graphene composite according to the present disclosure. By way of further examples, the part 200 may be a fuel tube, a heating or cooling line, a seal for a motor vehicle, an air conditioning (AC) rubber line, or fuel rubber hoses. However, the present disclosure is not limited to these applications.

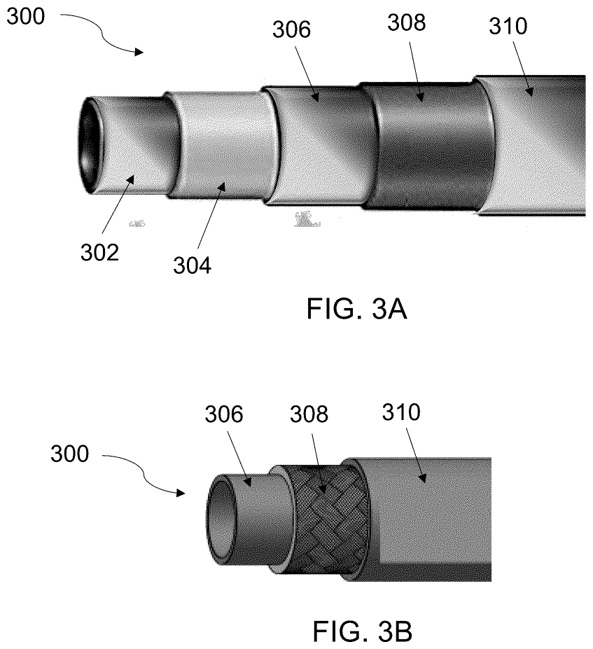

In a further aspect of the present disclosure shown in FIG. 3A, a multi-layer part 300 comprises the rubber-graphene composite as described previously. More specifically, the multi-layer part 300 comprises at least an inner layer 302, a middle layer 306, and an outer layer 310, wherein the inner, middle, and outer layers 302, 306, and 310 comprise the rubber-graphene composite according to the present disclosure. The multi-layer part further comprises a first intermediate layer 304 and a second intermediate layer 308. The first intermediate layer 304 is a resin layer, such as a polyamide resin layer, disposed between the inner layer 302 and the middle layer 306. The first intermediate layer 304 provides improved barrier performance, which is desirable in certain rubber-graphene composite parts such as air-conditioning hoses. Referring now to FIG. 3B, in one form of the present disclosure the second intermediate layer 308 is a braided polyester layer disposed between the middle layer 306 and the outer layer 310. The braided polyester layer provides mechanical reinforcement by reducing damage to the rubber layers (i.e., middle and outer layers, 306 and 310) caused by expansion due to high pressure and temperature conditions. In one form of the present disclosure, the inner layer 302, the middle layer 306, the outer layer 310, the first intermediate layer 304, and the second intermediate layer 308 are assembled into the multi-layer part 300 after the extrusion step 108 and before the curing step 110 as described previously.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A rubber-graphene composite comprising:
a paste comprising:
graphene;
a plasticizer; and
at least one additive selected from the group consisting of carbon black, biochar, and rice husk ash silica; and
a rubber matrix, wherein the paste is mixed with the rubber matrix.

2. The rubber-graphene composite according to claim 1, wherein the graphene comprises at least one of graphene nanoplatelets, graphene oxide, and reduced graphene oxide.

3. The rubber-graphene composite according to claim 1, wherein the plasticizer comprises at least one of paraffinic oil, naphthenic oil, vegetable oil, modified vegetable oil, dioctyl terephthalate (DOTP), trioctyl trimellitate (TOTM), and phenolic resin.

4. The rubber-graphene composite according to claim 1, wherein the rubber matrix is selected from the group consisting of butyl rubber, nitrile rubber, and ethylene-propylene-diene rubber.

5. The rubber-graphene composite according to claim 1 further comprising at least one additional additive selected from the group consisting of an antiozonant, an antioxidant, an activator, a cure accelerator, and a cure agent.

6. The rubber-graphene composite according to claim 5, wherein the activator comprises at least one of zinc oxide and stearic acid.

7. The rubber-graphene composite according to claim 5, wherein the cure accelerator comprises at least one of benzothiazole disulfide (MBTS), tetramethylthiuram disulfide (TMTD) and zinc dibenzyl dithiocarbamate (ZDBC).

8. The rubber-graphene composite according to claim 1, wherein the rubber-graphene composite has a shore A hardness between 60 and 80 measured according to ASTM D2240, a tensile strength at break greater than 10 MPa measured according to ASTM D412, an elongation at break greater than 240% measured according to ASTM D412, and an electrical resistivity of about 100 MΩ measured according to SAE J2260.

9. A part comprising the rubber-graphene composite according to claim 1.

10. A rubber-graphene composite comprising:
a paste comprising:
1-70 parts per hundred rubber (phr) total of graphene and a plasticizer;
0-200 parts per hundred rubber (phr) of N550 carbon black;
0-60 parts per hundred rubber (phr) of a conductive carbon black;
0-80 parts per hundred rubber (phr) rice husk ash silica; and
0-10 parts per hundred rubber (phr) of each of at least one additional additive selected from the group consisting of an antiozonant, an antioxidant, an activator, a cure accelerator, and a cure agent; and
100 parts per hundred rubber (phr) of a rubber matrix, wherein the paste is mixed with the rubber matrix.

11. The rubber-graphene composite according to claim 10, wherein the rubber-graphene composite has a shore A hardness between 60 and 80 measured according to ASTM D2240.

12. The rubber-graphene composite according to claim 10, wherein the rubber-graphene composite has a tensile strength at break greater than 10 MPa measured according to ASTM D412.

13. The rubber-graphene composite according to claim 10, wherein the rubber-graphene composite has an elongation at break greater than 240% measured according to ASTM D412.

14. The rubber-graphene composite according to claim 10, wherein the rubber-graphene composite has an electrical resistivity of about 100 MΩ measured according to SAE J2260.

15. A method for preparing a rubber-graphene composite, the method comprising:
mixing graphene with a plasticizer and at least one additive selected from the group consisting of carbon black, biochar, and rice husk ash silica to form a paste;
mixing the paste with a rubber matrix to form an intermediate composite;
accelerating the intermediate composite to form a final composite;
extruding the final composite; and
curing the final composite.

16. The method according to claim 15, wherein the graphene comprises at least one of graphene nanoplatelets, graphene oxide, and reduced graphene oxide.

17. The method according to claim 15, wherein the plasticizer comprises at least one of paraffinic oil, naphthenic oil, vegetable oil, modified vegetable oil, dioctyl terephthalate (DOTP), trioctyl trimellitate (TOTM), and phenolic resin.

18. The method according to claim 15, wherein the rubber matrix is selected from the group consisting of butyl rubber, nitrile rubber, and ethylene-propylene-diene rubber.

19. The method according to claim 15, wherein the step of mixing graphene with the plasticizer and the at least one additive to form the paste comprises mixing in a high-energy ball mill, wherein the ball milling time is 0.5-12 hours and the ball milling rotating speed is 300-600 rpm.

20. A part comprising the rubber-graphene composite manufactured according to the method of claim 15.
